(19) United States
(12) Patent Application Publication
(10) Pub. No.: US 2023/0127017 A1
(43) Pub. Date: Apr. 27, 2023

(54) MAGNETIC TAPE DRIVE AND METHOD OF OPERATING MAGNETIC TAPE DRIVE

(71) Applicant: FUJIFILM Corporation, Tokyo (JP)

(72) Inventor: Ren ISHIKAWA, Kanagawa (JP)

(73) Assignee: FUJIFILM Corporation, Tokyo (JP)

(21) Appl. No.: 18/049,313

(22) Filed: Oct. 25, 2022

(30) Foreign Application Priority Data
Oct. 26, 2021 (JP) 2021-174998

(51) Int. Cl. G11B 5/008; G11B 5/31

(52) U.S. Cl. CPC G11B 5/00813; G11B 5/31

(57) ABSTRACT

The magnetic tape drive includes: a first magnetic head that has a first magnetic element acting on a magnetic layer formed on a first surface of a magnetic tape; a first support member that is disposed at a position facing the first magnetic head with the magnetic tape interposed therebetween and faces a second surface which is a surface of the magnetic tape on a side opposite to the first surface; and an air membrane forming device that forms an air membrane between the magnetic tape and the first support member.

### CROSS-REFERENCE TO RELATED APPLICATION

This application claims priority from Japanese Patent Application No. 2021-174998, filed Oct. 26, 2021, the disclosure of which is incorporated herein by reference in its entirety.

### BACKGROUND

### Technical Field

The technique of the present disclosure relates to a magnetic tape drive and a method of operating a magnetic tape drive.

### Related Art

US8054582B discloses a magnetic tape device in which air is blown from an air blowing member onto a back surface of a magnetic tape on a side opposite to a front surface, and the magnetic tape is brought to face a magnetic head in a state of being floated by the air.

In Kyosuke Ono, “Design Theory of Contact Head Slider and Contact Vibration Characteristics”, C Edition of Proceedings of The Japan Society of Mechanical Engineers, Vol. 79, No. 797 (2013), pp. 90 to 106, adsorption contact characteristics of a thermal flying height control (TFC) head slider caused by a surface force between a head and a disk are newly evaluated through Johnson-Kendall-Robert (JKR) theory on the basis of the previously reported design theory of the contact slider, contact vibration characteristics of the contact head slider caused by the minute undulation of the disk are elucidated, and design conditions that enable stable contact are proposed.

### SUMMARY

One embodiment according to the technique of the present disclosure provides a magnetic tape drive and a method of operating a magnetic tape drive in which friction is restrained from being generated between a magnetic tape and a support member, as compared with a case where the support member that is provided on a side opposite to a magnetic head with the magnetic tape interposed therebetween is directly pressed against the magnetic tape.

According to a first aspect of the technique of the present disclosure, there is provided a magnetic tape drive comprising: a first magnetic head that has a first magnetic element acting on a magnetic layer formed on a first surface of a magnetic tape; a first support member that is disposed at a position facing the first magnetic head with the magnetic tape interposed therebetween and faces a second surface which is a surface of the magnetic tape on a side opposite to the first surface; and an air membrane forming device that forms an air membrane between the magnetic tape and the first support member.

According to a second aspect of the technique of the present disclosure, in the magnetic tape drive according to the first aspect, the air membrane forming device is a first ultrasonic vibration source that ultrasonically vibrates the first support member in a direction orthogonal to a longitudinal direction of the magnetic tape and orthogonal to a width direction of the magnetic tape to form the air membrane between the magnetic tape and the first support member.

According to a third aspect of the technique of the present disclosure, in the magnetic tape drive according to the second aspect, the air membrane is a squeeze membrane.

According to a fourth aspect of the technique of the present disclosure, in the magnetic tape drive according to the second aspect, the first ultrasonic vibration source vibrates the first support member at a frequency at which a squeeze membrane is generated between the magnetic tape and the first support member, and the frequency is a frequency higher than a natural frequency of the magnetic tape.

According to a fifth aspect of the technique of the present disclosure, in the magnetic tape drive according to any one of the second to fourth aspects, the first ultrasonic vibration source vibrates the first support member at a frequency at which amplitude of the magnetic tape is within a predetermined range.

According to a sixth aspect of the technique of the present disclosure, in the magnetic tape drive according to any one of the second to fifth aspects, a processor is further provided, and the processor controls an operation of the first ultrasonic vibration source on the basis of magnetic tape information which is information regarding the magnetic tape.

According to a seventh aspect of the technique of the present disclosure, in the magnetic tape drive according to the sixth aspect, the magnetic tape information includes information regarding a transport state of the magnetic tape and/or information regarding a property of the magnetic tape.

According to an eighth aspect of the technique of the present disclosure, in the magnetic tape drive according to the seventh aspect, the information regarding the transport state of the magnetic tape includes information regarding a transport speed of the magnetic tape, information regarding tension generated in the magnetic tape, and/or information regarding amplitude of the magnetic tape.

According to a ninth aspect of the technique of the present disclosure, in the magnetic tape drive according to the seventh aspect, the information regarding the property of the magnetic tape includes information regarding a thickness of the magnetic tape and/or information regarding a material of the magnetic tape.

According to a tenth aspect of the technique of the present disclosure, in the magnetic tape drive according to any one of the seventh to ninth aspects, a sensor that detects the transport state of the magnetic tape is further provided, and the processor controls the operation of the first ultrasonic vibration source on the basis of a detection result of the sensor.

According to an eleventh aspect of the technique of the present disclosure, in the magnetic tape drive according to any one of the first to tenth aspects, a leaf spring type suspension that supports the first magnetic head is further provided, the first magnetic head is provided at a distal end portion of the suspension, and the suspension displaces the first magnetic head in a direction approaching the magnetic tape.

According to a twelfth aspect of the technique of the present disclosure, in the magnetic tape drive according to any one of the first to eleventh aspects, a position adjusting actuator that adjusts a position of the first magnetic head along a direction orthogonal to a longitudinal direction of the magnetic tape and orthogonal to a width direction of the magnetic tape is further provided.

According to a thirteenth aspect of the technique of the present disclosure, in the magnetic tape drive according to any one of the first to twelfth aspects, the magnetic tape has a magnetic layer formed on the second surface, a second magnetic head that has a second magnetic element acting on the magnetic layer formed on the second surface, a second support member that is disposed at a position facing the second magnetic head with the magnetic tape interposed therebetween and faces the first surface, and an air membrane forming device that forms an air membrane between the magnetic tape and the second support member are further provided, and the magnetic tape drive switches between a first state in which the first magnetic element acts on the magnetic layer formed on the first surface and a second state in which the second magnetic element acts on the magnetic layer formed on the second surface.

According to a fourteenth aspect of the technique of the present disclosure, in the magnetic tape drive according to any one of the first to twelfth aspects, the magnetic tape has a magnetic layer formed on the second surface, a second magnetic head that has a second magnetic element acting on the magnetic layer formed on the second surface, a second support member that is disposed at a position facing the second magnetic head with the magnetic tape interposed therebetween and faces the first surface, and an air membrane forming device that forms an air membrane between the magnetic tape and the second support member are further provided, and the second magnetic head and the second support member are disposed at different positions from the first magnetic head and the first support member in a longitudinal direction of the magnetic tape, respectively.

According to a fifteenth aspect of the technique of the present disclosure, there is provided a method of operating a magnetic tape drive, comprising: forming an air membrane between a magnetic tape and a support member that is disposed at a position facing a magnetic head with the magnetic tape interposed therebetween; causing the magnetic tape to run in a state in which the air membrane is formed; and causing the magnetic head to act on a magnetic layer of the magnetic tape.

### BRIEF DESCRIPTION OF THE DRAWINGS

FIG. 1 is a diagram showing an example of a schematic configuration of a magnetic tape drive.

FIG. 2 is an enlarged view showing an example of the schematic configuration of the magnetic tape drive.

FIG. 3 is a plan view of a support member viewed from a side of a feed head and a rewind head.

FIG. 4 is an enlarged view of a vicinity of the feed head.

FIG. 5 is a diagram showing a correspondence relationship between a data element and a data track.

FIG. 6 is an enlarged view of the data element.

FIG. 7 is a block diagram showing a configuration example of a controller.

FIG. 8 is a block diagram showing a configuration example of the controller.

FIG. 9 is a flowchart showing an operation procedure of the magnetic tape drive.

FIG. 10 is a perspective view showing an example of the feed head.

FIG. 11 is a perspective view showing an example of a piezoelectric bimorph element.

FIG. 12 is a side view showing an operation example of the piezoelectric bimorph element.

FIG. 13 is an enlarged view showing an example of the schematic configuration of the magnetic tape drive.

FIG. 14 is an enlarged view showing an example of the schematic configuration of the magnetic tape drive.

FIG. 15 is an enlarged view showing an example of the schematic configuration of the magnetic tape drive.

FIG. 16 is an enlarged view showing an example of the schematic configuration of the magnetic tape drive.

FIG. 17 is an enlarged view showing an example of the schematic configuration of the magnetic tape drive.

### DETAILED DESCRIPTION

### First Embodiment

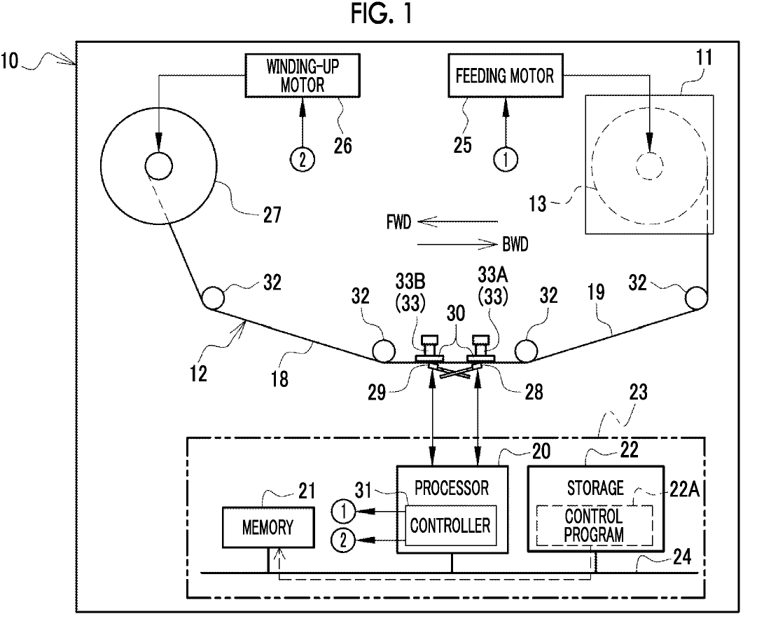

As shown in FIG. 1 as an example, a cartridge 11 is loaded in a magnetic tape drive 10. A cartridge reel 13 around which a magnetic tape 12 is wound is housed in the cartridge 11. The magnetic tape drive 10 records data on the magnetic tape 12 fed out from the cartridge reel 13. Further, the magnetic tape drive 10 reads the data recorded on the magnetic tape 12. The magnetic tape drive 10 is an example of the “magnetic tape drive” according to the technique of the present disclosure.

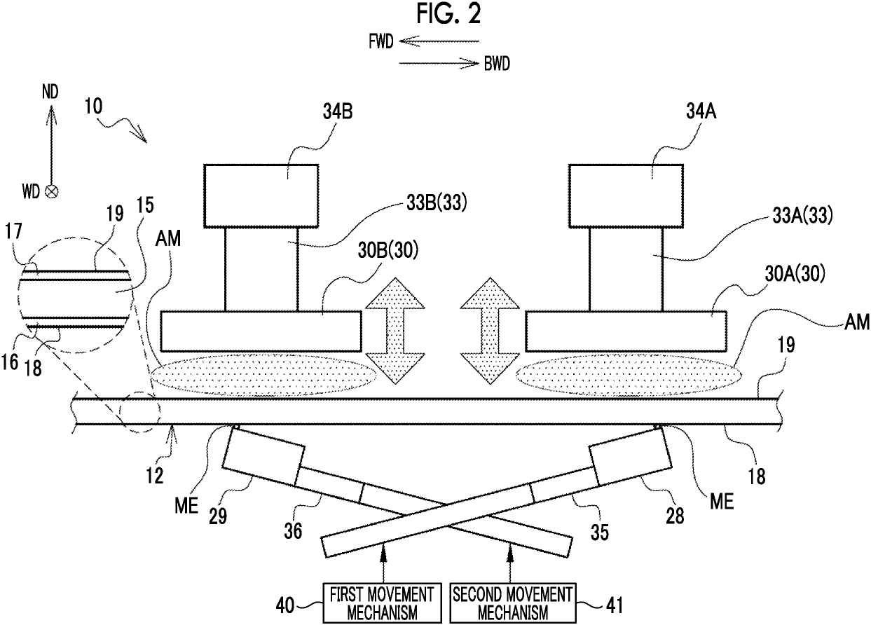

The magnetic tape 12 has, for example, a configuration in which a magnetic layer 16 and a back coating layer 17 are formed on a base film 15 (see FIG. 2). Data is recorded on the magnetic layer 16. The magnetic layer 16 contains ferromagnetic powder. As the ferromagnetic powder, ferromagnetic powder usually used in the magnetic layer of various magnetic recording media can be used. Preferable specific examples of the ferromagnetic powder can include hexagonal ferrite powder. Instead of the hexagonal ferrite powder, for example, hexagonal strontium ferrite powder or hexagonal barium ferrite powder can be used. The back coating layer 17 contains, for example, non-magnetic powder, such as carbon black. The base film 15 is also called a support and is formed of, for example, polyethylene terephthalate, polyethylene naphthalate, or polyamide. A non-magnetic layer may be formed between the base film 15 and the magnetic layer 16. The magnetic tape 12 is an example of the “magnetic tape” according to the technique of the present disclosure.

A surface of the magnetic tape 12 on which the magnetic layer 16 is formed is a front surface 18 of the magnetic tape 12. On the other hand, a surface on which the back coating layer 17 is formed is a back surface 19 of the magnetic tape 12. The front surface 18 is an example of the “first surface” according to the technique of the present disclosure, and the back surface 19 is an example of the “second surface” according to the technique of the present disclosure. Further, the magnetic layer 16 is an example of the “magnetic layer” according to the technique of the present disclosure.

The magnetic tape drive 10 comprises a computer 23 that includes a processor 20, a memory 21, and a storage 22. The processor 20, the memory 21, and the storage 22 are connected to a bus 24. The memory 21 is, for example, a random access memory (RAM), and temporarily stores various types of information. The storage 22 is a computer-readable non-transitory storage medium, and stores various parameters and various programs. An example of the storage 22 includes a hard disk drive or a solid state drive. The processor 20 is, for example, a central processing unit (CPU). A control program 22A is stored in the storage 22. The processor 20 operates as a controller 31 by loading the control program 22A into the memory 21 and executing processing in accordance with the control program 22A. The controller 31 controls the operation of each unit of the magnetic tape drive 10 in an integrated manner. The processor 20 is an example of the “processor” according to the technique of the present disclosure.

The magnetic tape drive 10 comprises a feeding motor 25, a winding-up motor 26, a wind-up reel 27, a feed head 28, a rewind head 29, and a support member 30. The feed head 28 and the rewind head 29 are an example of the “first magnetic head” according to the technique of the present disclosure. Hereinafter, for convenience of description, in a case where it is not necessary to distinguish between the feed head 28 and the rewind head 29, the feed head 28 and the rewind head 29 may be collectively referred to as “magnetic head”.

The feeding motor 25 rotates the cartridge reel 13 provided in the cartridge 11 under the control of the controller 31. The magnetic tape 12 fed out from the cartridge reel 13 is wound up on the wind-up reel 27. Further, the magnetic tape 12 wound up on the wind-up reel 27 is rewound on the cartridge reel 13. The winding-up motor 26 rotates the wind-up reel 27 under the control of the controller 31.

The magnetic tape 12 runs in a feed direction FWD or a rewind direction BWD while being guided by a plurality of guide rollers 32, by the drive of the feeding motor 25 and the winding-up motor 26. The feed direction FWD is a direction from the cartridge reel 13 toward the wind-up reel 27. The rewind direction BWD is, on the contrary, a direction from the wind-up reel 27 toward the cartridge reel 13. Further, in the magnetic tape 12, the rotational speed and/or the rotational torque of the feeding motor 25 and the winding-up motor 26 is adjusted so that the running speed and the tension during running are adjusted to appropriate values, but this is merely an example. For example, the rotational speed of the feeding motor 25 and the winding-up motor 26 (for example, the difference in rotational frequency between the feeding motor 25 and the winding-up motor 26) is adjusted, whereby the running speed and the tension during running may be adjusted to appropriate values.

The feed head 28 and the rewind head 29 are disposed on the side of the front surface 18 of the magnetic tape 12 in order to access the magnetic layer 16. The feed head 28 and the rewind head 29 record data on the magnetic layer 16. Further, the feed head 28 and the rewind head 29 read the data recorded on the magnetic layer 16.

The feed head 28 operates in a case where the magnetic tape 12 is running in the feed direction FWD. In other words, the feed head 28 operates in a case where the magnetic tape 12 is fed out from the cartridge reel 13. On the other hand, the rewind head 29 operates in a case where the magnetic tape 12 is running in the rewind direction BWD. In other words, the rewind head 29 operates in a case where the magnetic tape 12 is rewound on the cartridge reel 13.

The feed head 28 and the rewind head 29 have the same structure except that the feed head 28 and the rewind head 29 operate at different timings from each other. The feed head 28 and the rewind head 29 are small magnetic heads, such as a magnetic head used for a hard disk drive.

As shown in FIG. 2 as an example, the feed head 28 and the rewind head 29 are provided at the distal ends of the leaf spring type suspensions 35 and 36, respectively. The proximal ends of the suspensions 35 and 36 are movably attached to the frame of the magnetic tape drive 10 via, for example, an arm. The suspensions 35 and 36 displace the feed head 28 and the rewind head 29 in a direction approaching the magnetic tape 12, respectively. That is, the magnetic heads are pressed against the magnetic tape 12 by the leaf spring type suspensions 35 and 36, respectively. Meanwhile, a floating force is generated in the magnetic head because of factors, such as the shape of the magnetic head, in the entrained flow of the magnetic tape 12. Gaps are generated between the magnetic tape 12 and the magnetic heads because of the balance between the spring loads of the suspensions 35 and 36 on the magnetic heads and the floating forces of the magnetic heads.

Here, the spring loads generated on the magnetic heads by the suspensions 35 and 36 are each, for example, about 0.01 to 0.1 N, but this is merely an example. Although the details will be described later, the floating state of the magnetic tape 12 with respect to the support member 30 need only be maintained, and the spring load may be smaller than 0.01 N or larger than 0.1 N. For example, the spring load changes by changing the shape of the magnetic head and/or the shapes of the suspensions 35 and 36.

The suspensions 35 and 36 may retract the feed head 28 and the rewind head 29 to a standby position away from the magnetic tape 12 when the feed head 28 and the rewind head 29 are not in operation.

The support member 30 is disposed at a position facing the feed head 28 and the rewind head 29 with the magnetic tape 12 interposed therebetween. Specifically, a feed support member 30A is disposed at a position facing the feed head 28 with the magnetic tape 12 interposed therebetween. Further, a rewind support member 30B is disposed at a position facing the rewind head 29 with the magnetic tape 12 interposed therebetween. The feed support member 30A and the rewind support member 30B are an example of the “first support member” according to the technique of the present disclosure. Hereinafter, for convenience of description, in a case where it is not necessary to distinguish between the feed support member 30A and the rewind support member 30B, the feed support member 30A and the rewind support member 30B are also simply referred to as “support member 30”.

The support member 30 faces the back surface 19 of the magnetic tape 12. Specifically, the support member 30 is a flat plate-shaped member. The part of the support member 30 facing the back surface of the magnetic tape 12 is a plane. The length of the support member 30 in the transport direction of the magnetic tape 12 is not particularly limited, but need only be a length capable of supporting the magnetic tape 12 to the extent that the magnetic head can read/write with respect to the magnetic tape 12. Further, examples of a material of the support member 30 include an abrasive material of aluminum, but this is merely an example. The material of the support member 30 need only be appropriately set from the viewpoint of rigidity, durability, wear resistance, or the like, and may be, for example, a metal other than aluminum, a resin, or the like.

Meanwhile, in a case where the magnetic head is brought into contact with the magnetic tape 12, a part of the magnetic tape 12 may be peeled off due to friction to form debris, which may be attached to the magnetic head or deposited on the magnetic tape 12. In order to restrain this debris from being generated, the magnetic head has a structure, such as that used for the hard disk drive, as described above.

However, unlike the case of the hard disk drive, since the magnetic tape 12 is a more flexible medium than the magnetic disk provided in the hard disk drive, fluttering (that is, an increase in amplitude) may occur when the magnetic tape 12 is transported. As a result, the variance in the gap (that is, spacing) between the magnetic head and the magnetic tape 12 may become large. As a method of restraining the magnetic tape 12 from fluttering, for example, there is a method of supporting the magnetic head from the back surface of the magnetic tape 12 by using a guide roller. However, in this method, since the magnetic tape 12 is supported by a curved surface, even a slight change in the position of the magnetic head in the transport direction of the magnetic tape 12 may cause a large change in spacing. Further, in a case where a planar structure, instead of the guide roller, is directly pressed against the magnetic tape 12 to support the magnetic tape 12, friction occurs between the magnetic tape 12 and the structure, debris is generated, and the running of the magnetic tape 12 may become unstable due to frictional resistance.

In that respect, the magnetic tape drive 10 according to the technique of the present disclosure comprises an air membrane forming device 33. The air membrane forming device 33 forms an air membrane AM between the support member 30 and the magnetic tape 12. The air membrane forming device 33 is an example of the “air membrane forming device” according to the technique of the present disclosure.

The air membrane forming device 33 comprises ultrasonic vibration sources 33A and 33B. The ultrasonic vibration source 33A is connected to the feed support member 30A. Further, the ultrasonic vibration source 33B is connected to the rewind support member 30B. The ultrasonic vibration sources 33A and 33B ultrasonically vibrate the support member 30 in a direction orthogonal to a longitudinal direction of the magnetic tape 12 and orthogonal to a width direction WD of the magnetic tape 12 (that is, a normal direction ND of the magnetic tape 12). With this, the air membrane AM is formed between the support member 30 and the magnetic tape 12.

Descriptions based on various theories have been made for the flotation of an object by ultrasonic vibration. That is, in a case where two planes facing each other approach each other, pressure caused by a change in the viscosity of a fluid (for example, air) existing between the planes is generated (that is, a squeeze effect). As a result, there is a theory that an air membrane (that is, a squeeze membrane) having pressure generated by the squeeze effect is formed. Further, there is also a theory that a sound field is formed between a supporting object and a floating object (for example, the support member 30 and the magnetic tape 12) by ultrasonic vibration, and the object is floated by the difference in energy density of the sound wave of the upper and lower surfaces of the object (for example, the front surface 18 and the back surface 19 of the magnetic tape 12). In either case, the vibration of the ultrasonic vibration sources 33A and 33B forms the air membrane AM between the support member 30 and the magnetic tape 12. The air membrane AM is, for example, a squeeze membrane. The ultrasonic vibration sources 33A and 33B are an example of the “first ultrasonic vibration source” according to the technique of the present disclosure.

As a result, in a case where ultrasonic vibration is applied to the support member 30 from the ultrasonic vibration sources 33A and 33B, a floating force is generated in the magnetic tape 12 facing the support member 30. An example of the ultrasonic vibration sources 33A and 33B includes an ultrasonic vibration source using a piezoelectric element. The piezoelectric element is, for example, lead zirconate titanate (PZT; Pb(Zr,Ti)O₃). For example, in a case where a voltage of about 10 to 100 V is applied to the piezoelectric element, a flotation height of about several tens to hundreds of nanometers (that is, the distance between the magnetic tape 12 and the support member 30) can be obtained. Further, 1 N or more can be obtained as the floating force generated in the magnetic tape 12. With this, the floating state of the magnetic tape 12 can be ensured, for example, even in a case where the magnetic head is pressed against the magnetic tape 12 with a force of about 1 N.

Further, the ultrasonic vibration sources 33A and 33B may be ultrasonic vibration sources using a laminated piezoelectric element. It is possible to increase the stroke of the ultrasonic vibration source by using the laminated piezoelectric element. With this, the flotation height is further obtained and the magnetic tape 12 is further separated from the support member 30, so that it is realized that the magnetic tape 12 is transported in a state in which the influence of the surface state (that is, unevenness or surface roughness) of the magnetic tape 12 is reduced.

The ultrasonic vibration sources 33A and 33B vibrate the support member 30 by oscillating at a predetermined frequency. For example, the ultrasonic vibration sources 33A and 33B vibrate the support member 30 at a frequency at which the squeeze membrane is generated as the air membrane AM. Further, the ultrasonic vibration sources 33A and 33B vibrate the support member 30 at a frequency higher than the natural frequency of the magnetic tape 12. The support member 30 having a frequency equal to or higher than the natural frequency of the magnetic tape 12 is vibrated, whereby the magnetic tape 12 cannot follow the vibration of the support member 30. With this, the influence of the vibration of the support member 30 on the magnetic tape 12 is restrained.

Further, the ultrasonic vibration sources 33A and 33B vibrate the support member 30 at a frequency at which the amplitude of the magnetic tape 12 is within the predetermined range. The amplitude of the magnetic tape 12 within a predetermined range is desirably within a range equal to or smaller than the spacing between the magnetic head and the magnetic tape 12, and examples thereof include 1 nanometer or less.

The ultrasonic vibration sources 33A and 33B are fixed to the magnetic tape drive 10 via fixing members 34A and 34B, respectively. The fixing members 34A and 34B are provided on the sides of the ultrasonic vibration sources 33A and 33B opposite to the side connected to the support member 30, respectively. An example of the fixing members 34A and 34B includes a flat plate member made of metal. The fixing members 34A and 34B are fixed to the housing (not shown) of the magnetic tape drive 10 by, for example, a fastening member (not shown).

A first movement mechanism 40 is connected to the suspension 35, and a second movement mechanism 41 is connected to the suspension 36. The first movement mechanism 40 moves the feed head 28 together with the suspension 35 in the width direction WD of the magnetic tape 12. Similarly, the second movement mechanism 41 moves the rewind head 29 together with the suspension 36 in the width direction WD of the magnetic tape 12. The first movement mechanism 40 and the second movement mechanism 41 include, for example, an actuator, such as a voice coil motor or a piezoelectric element.

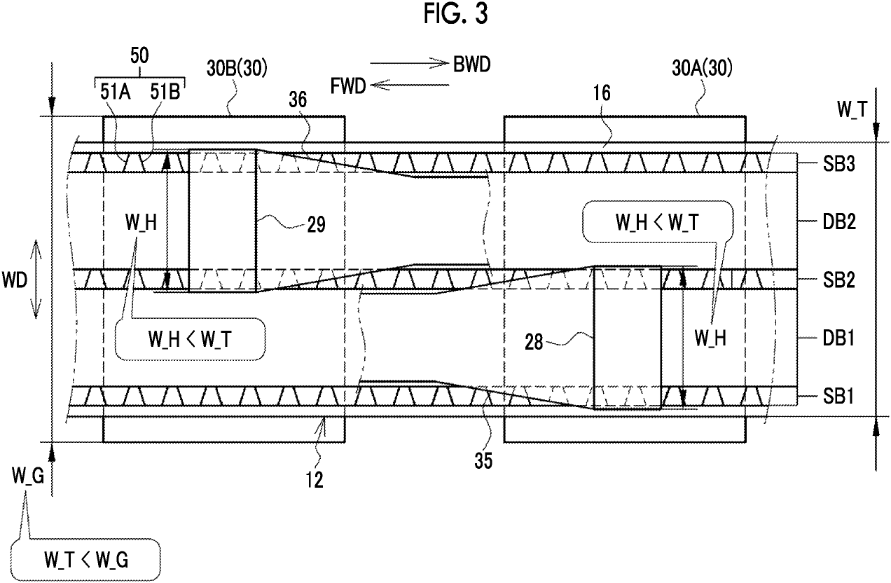

As shown in FIG. 3 as an example, the feed head 28 and the rewind head 29 are disposed so as to be shifted from each other in the feed direction FWD and the rewind direction BWD (that is, the longitudinal direction of the magnetic tape 12) such that the feed head 28 and the rewind head 29 do not interfere with each other. A width W_H of each of the feed head 28 and the rewind head 29 is smaller than a width W_T of the magnetic tape 12. Specifically, the width W_H of each of the feed head 28 and the rewind head 29 is about ½ of the width W_T of the magnetic tape 12. The width W_T of the magnetic tape 12 is, for example, 12.65 mm, and the width W_H of each of the feed head 28 and the rewind head 29 is, for example, 6.5 mm to 7.0 mm. Incidentally, the depth and height of each of the feed head 28 and the rewind head 29 are also smaller than the width W_T of the magnetic tape 12, and are, for example, about several mm. Further, a width W_G of the support member 30 is larger than the width W_T of the magnetic tape 12.

The magnetic layer 16 has three servo bands SB1, SB2, and SB3, and two data bands DB1 and DB2 on which data is recorded. The servo bands SB1 to SB3 and the data bands DB 1 and DB2 are formed along the feed direction FWD and the rewind direction BWD. The servo bands SB1 to SB3 are arranged at an equal interval along the width direction WD of the magnetic tape 12. The data band DB1 is disposed between the servo bands SB1 and SB2, and the data band DB2 is disposed between the servo bands SB2 and SB3. That is, the servo bands SB1 to SB3 and the data bands DB1 and DB2 are alternately arranged along the width direction WD of the magnetic tape 12.

A servo pattern 50 is recorded on the servo bands SB1 to SB3. A plurality of the servo patterns 50 are provided at an equal interval along, for example, the feed direction FWD and the rewind direction BWD. The servo pattern 50 is composed of a pair of line-symmetrical linear magnetization regions 51A and 51B. The pair of linear magnetization regions 51A and 51B are non-parallel to each other and form a predetermined angle with respect to a virtual straight line along the width direction of the magnetic tape 12. The predetermined angle is, for example, 10 degrees. In this case, the angle formed by the magnetization region 51A and the virtual straight line along the width direction of the magnetic tape 12 is 5 degrees, and the angle formed by the magnetization region 51B and the virtual straight line is -5 degrees. The magnetization region 51A is tilted toward the side of the rewind direction BWD, and the magnetization region 51B is tilted toward the side of the feed direction FWD. The servo pattern 50 is used, for example, for servo control. The servo control refers to control to move the feed head 28 and the rewind head 29 in the width direction WD of the magnetic tape 12 through the first movement mechanism 40 and the second movement mechanism 41.

The feed head 28 records data on the data band DB1 and reads the data recorded on the data band DB1. Further, the feed head 28 reads the servo pattern 50 recorded on the servo bands SB1 and SB2. In other words, the feed head 28 takes charge of a first region divided with respect to the width direction WD of the magnetic tape 12. The first region in this case is the servo bands SB1 and SB2 and the data band DB1.

On the other hand, the rewind head 29 records data on the data band DB2 and reads the data recorded on the data band DB2. Further, the rewind head 29 reads the servo pattern 50 recorded on the servo bands SB2 and SB3. In other words, the rewind head 29 takes charge of a second region divided with respect to the width direction WD of the magnetic tape 12. The second region in this case is the servo bands SB2 and SB3 and the data band DB2.

In this way, the feed head 28 is in charge of recording data on the data band DB1 and reading the data recorded on the data band DB1. Further, the rewind head 29 is in charge of recording data on the data band DB2 and reading the data recorded on the data band DB2. That is, two magnetic heads are provided for two data bands DB1 and DB2.

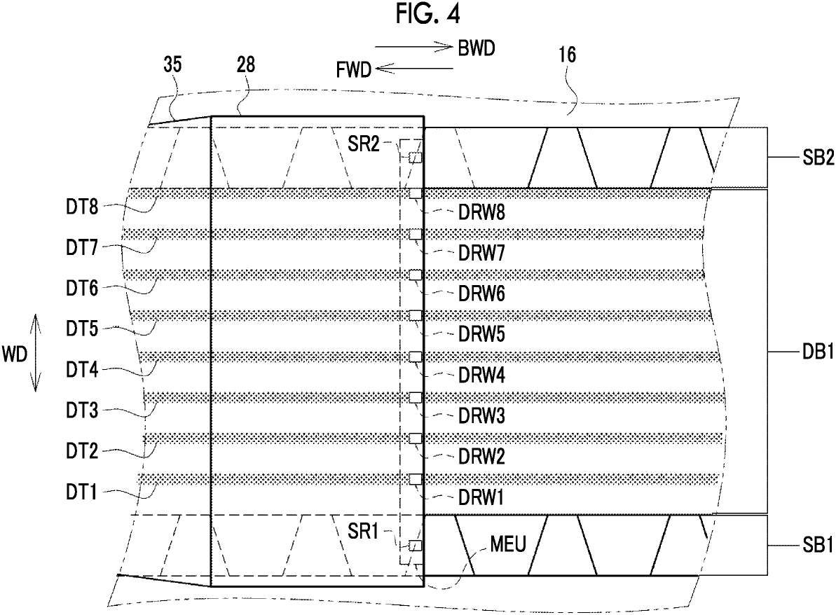

As shown in FIG. 4 as an example, the feed head 28 has a magnetic element unit MEU consisting of a plurality of magnetic elements on a surface facing the magnetic layer 16. The plurality of magnetic elements act on the magnetic layer 16. The feed head 28 causes the magnetic element to magnetically act on the magnetic layer 16 by bringing the magnetic element into contact with or close to the magnetic layer 16. The term “close” as used herein means that the gap between the magnetic layer 16 and the magnetic element, which is called spacing, is maintained on, for example, the order of several nm. The magnetic element is an example of the “first magnetic element” according to the technique of the present disclosure.

The magnetic element unit MEU has two servo pattern reading elements SR1 and SR2, and eight data elements DRW1, DRW2, DRW3, DRW4, DRW5, DRW6, DRW7, and DRW8. Hereinafter, in a case where it is not necessary to particularly distinguish between the servo pattern reading elements SR1 and SR2 and between the data elements DRW1 to DRW8, the servo pattern reading elements SR1 and SR2 are collectively referred to as a servo pattern reading element SR, and the data elements DRW1 to DRW8 are collectively referred to as a data element DRW.

The servo pattern reading element SR1 is provided at a position corresponding to the servo band SB1, and the servo pattern reading element SR2 is provided at a position corresponding to the servo band SB2. The data elements DRW1 to DRW8 are provided between the servo pattern reading elements SR1 and SR2. The data elements DRW1 to DRW8 are arranged at an equal interval along the width direction WD of the magnetic tape 12. The data elements DRW1 to DRW8 simultaneously record data and/or read data with respect to eight data tracks DT1, DT2, DT3, DT4, DT5, DT6, DT7, and DT8. Hereinafter, in a case where it is not necessary to particularly distinguish between the data tracks DT1, DT2, DT3, DT4, DT5, DT6, DT7, and DT8, the data tracks DT1, DT2, DT3, DT4, DT5, DT6, DT7, and DT8 are referred to as “data track DT”.

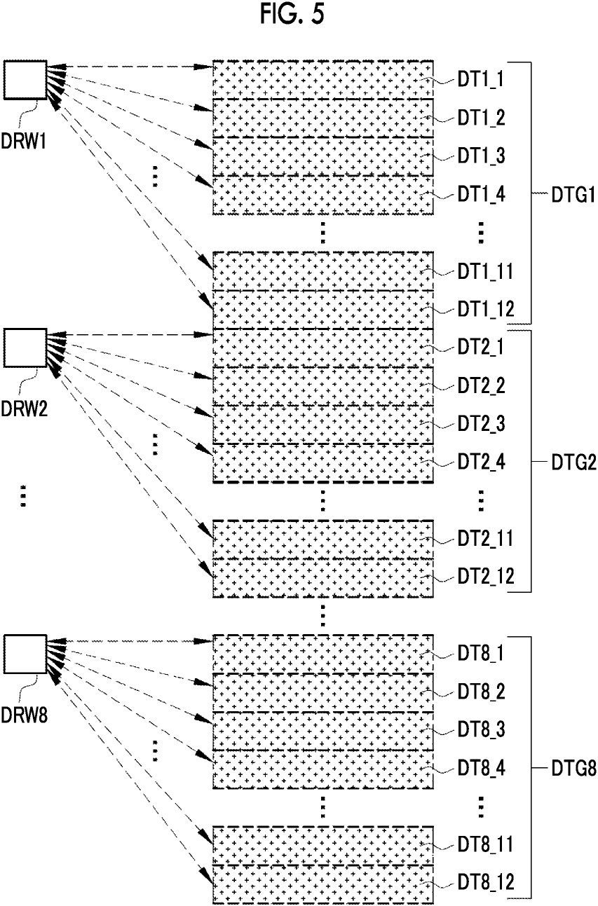

As shown in FIG. 5 as an example, the data track DT has a divided data track group DTG. The data tracks DT1 to DT8 shown in FIG. 4 correspond to the divided data track groups DTG1 to DTG8 shown in FIG. 5, respectively. Hereinafter, in a case where it is not necessary to particularly distinguish between the divided data track groups DTG1 to DTG8, the divided data track groups DTG1 to DTG8 are referred to as “divided data track group DTG”.

The divided data track group DTG1 is a set of a plurality of divided data tracks obtained by dividing the data track DT in the width direction WD. In the example shown in FIG. 5, as an example of the divided data track group DTG1, the divided data tracks DT1_1, DT1_2, DT1_3, DT1_4, ..., DT1_11, and DT1_12 obtained by dividing the data track DT into 12 equal parts in the width direction WD are shown. The data element DRW1 is in charge of magnetic processing on the divided data track group DTG1. That is, the data element DRW1 is in charge of recording data on the divided data tracks DT1_1, DT1_2, DT1_3, DT1_4, ..., DT1_11, and DT1_12, and reading data from the divided data tracks DT1_1, DT1_2, DT1_3, DT1_4, ..., DT1_11, and DT1_12.

The data elements DRW2 to DRW8 are in charge of magnetic processing on the divided data track group DTG of the data track DT corresponding to the respective data elements DRW, as in the data element DRW1.

The data element DRW shifts to a position corresponding to one designated divided data track out of the 12 divided data tracks with the movement of the feed head 28 in the width direction WD performed by the first movement mechanism 40. The data element DRW is fixed at a position corresponding to one designated data track DT by servo control using the servo pattern 50.

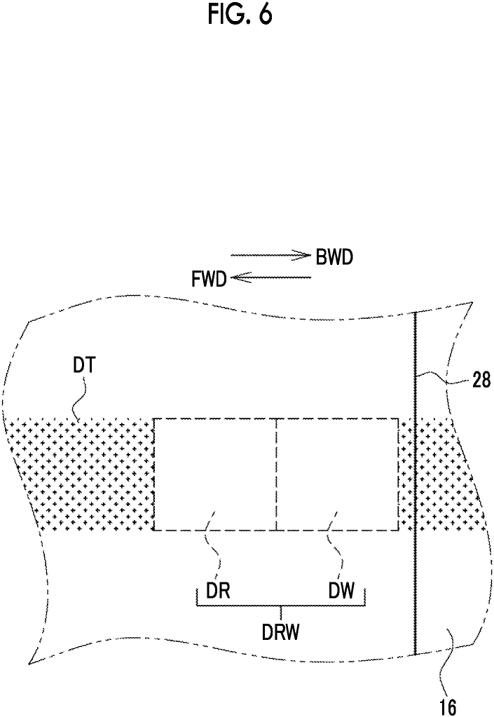

As shown in FIG. 6 as an example, the data element DRW includes a data recording element DW and a data reading element DR. The data recording element DW records data on the data track DT. The data reading element DR reads the data recorded on the data track DT.

The data recording element DW is disposed on the upstream side of the feed direction FWD, and the data reading element DR is disposed on the downstream side of the feed direction FWD. The reason for such a disposition is that the data reading element DR immediately reads the data recorded by the data recording element DW to check errors.

Although illustration and detailed description are omitted, the rewind head 29 also has two servo pattern reading elements SR corresponding to the servo bands SB2 and SB3 and eight data elements DRW provided between two servo pattern reading elements SR. The data element DRW records data and/or reads data with respect to 96 data tracks DT of the data band DB2. The data element DRW includes a data recording element DW disposed on the upstream side of the rewind direction BWD and a data reading element DR disposed on the downstream side of the rewind direction BWD.

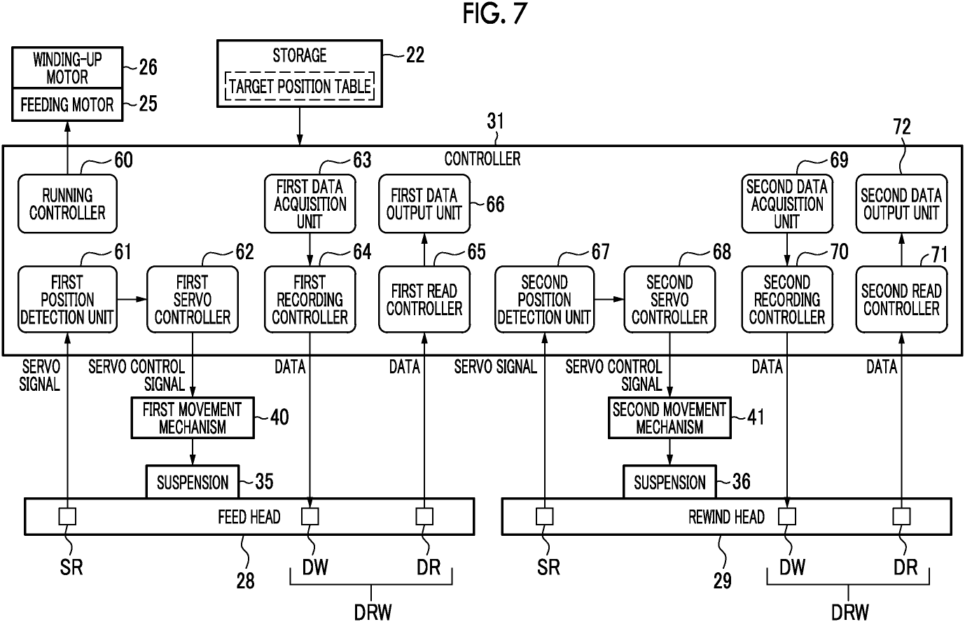

As shown in FIG. 7 as an example, the controller 31 functions as a running controller 60, a first position detection unit 61, a first servo controller 62, a first data acquisition unit 63, a first recording controller 64, a first read controller 65, a first data output unit 66, a second position detection unit 67, a second servo controller 68, a second data acquisition unit 69, a second recording controller 70, a second read controller 71, and a second data output unit 72.

The running controller 60 controls the drive of the feeding motor 25 and the winding-up motor 26 to cause the magnetic tape 12 to run in the feed direction FWD or the rewind direction BWD. Further, the running controller 60 adjusts the rotational speed and the rotational torque of the feeding motor 25 and the winding-up motor 26 to adjust the tension during running and the running speed of the magnetic tape 12 to appropriate values.

A servo signal based on the servo pattern 50 read by the servo pattern reading element SR of the feed head 28 is input to the first position detection unit 61. The servo signal is an intermittent pulse corresponding to the magnetization regions 51A and 51B. The first position detection unit 61 detects the position of the servo pattern reading element SR in the width direction WD of the servo band SB, that is, the position of the feed head 28 in the width direction WD with respect to the magnetic tape 12, on the basis of the pulse interval of the servo signal. The first position detection unit 61 outputs the detection result of the position of the feed head 28 in the width direction WD to the first servo controller 62.

Two types of servo signals based on the servo pattern 50 read by two servo pattern reading elements SR are input to the first position detection unit 61. The first position detection unit 61 calculates the average value of the pulse intervals of two types of servo signals. Then, the position of the feed head 28 in the width direction WD is detected on the basis of the calculated average value.

The first servo controller 62 compares the detection result of the position of the feed head 28 from the first position detection unit 61 with the target position of the feed head 28. In a case where the detection result is the same as the target position, the first servo controller 62 does nothing. In a case where the detection result deviates from the target position, the first servo controller 62 outputs a servo control signal for making the position of the feed head 28 equal to the target position, to the first movement mechanism 40. The first movement mechanism 40 operates so as to make the position of the feed head 28 equal to the target position according to the servo control signal. The target position is stored in the storage 22, for example, in the form of a data table (that is, a target position table) in which the values corresponding to the respective data tracks DT1 to DT8 are registered.

The first data acquisition unit 63 reads out and acquires the data to be recorded in the data band DB1 by the feed head 28 from, for example, a host computer (not shown) connected to the magnetic tape drive 10. The first data acquisition unit 63 outputs the data acquired from the host computer, to the first recording controller 64.

The first recording controller 64 encodes the data input from the first data acquisition unit 63 into a digital signal for recording. Then, the first recording controller 64 causes the pulse current corresponding to the digital signal to flow through the data recording element DW of the feed head 28, thereby causing the data recording element DW to record the data on the designated data track DT in the data band DB 1.

The first read controller 65 controls the operation of the data reading element DR of the feed head 28, thereby causing the data reading element DR to read the data recorded on the designated data track DT in the data band DB 1. The data read by the data reading element DR is a pulse-shaped digital signal. The first read controller 65 outputs this pulse-shaped digital signal to the first data output unit 66.

The first data output unit 66 decodes the pulse-shaped digital signal output from the first read controller 65 to obtain data. For example, the first data output unit 66 outputs data to the host computer.

The second position detection unit 67, the second servo controller 68, the second data acquisition unit 69, the second recording controller 70, the second read controller 71, and the second data output unit 72 have the same functions as the first position detection unit 61, the first servo controller 62, the first data acquisition unit 63, the first recording controller 64, the first read controller 65, and the first data output unit 66, except that the above-described feed head 28 is replaced with the rewind head 29 and the data band DB1 is replaced with the data band DB2. Therefore, detailed description thereof will be omitted.

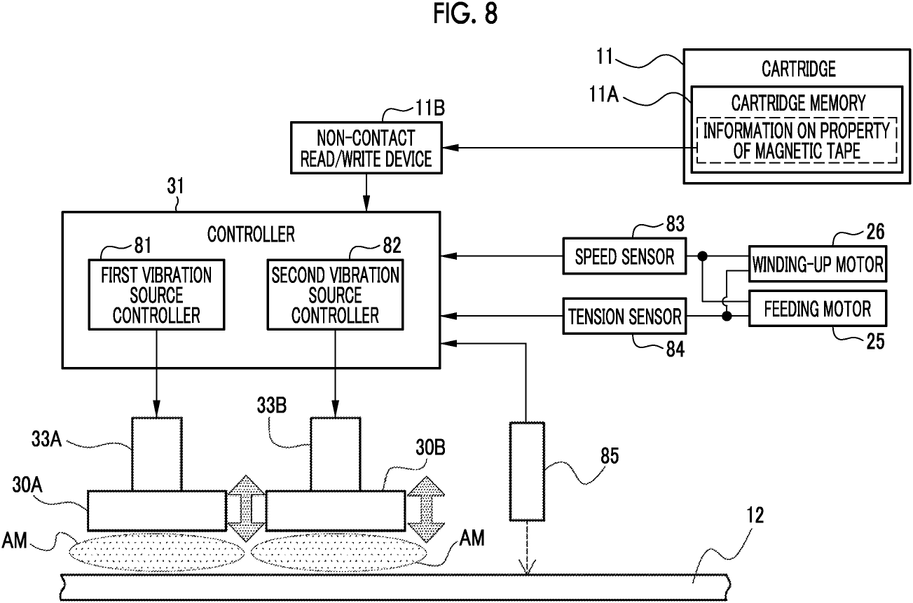

As shown in FIG. 8 as an example, the controller 31 functions as a first vibration source controller 81 and a second vibration source controller 82. The first vibration source controller 81 controls the operation of the ultrasonic vibration source 33A. Further, the second vibration source controller 82 controls the operation of the ultrasonic vibration source 33B.

The first vibration source controller 81 and the second vibration source controller 82 control the operations of the ultrasonic vibration sources 33A and 33B, respectively, on the basis of magnetic tape information which is information regarding the magnetic tape 12. The magnetic tape information includes information regarding the transport state of the magnetic tape 12 and information regarding the property of the magnetic tape 12.

Among the magnetic tape information, the information regarding the transport state of the magnetic tape 12 includes information regarding the transport speed of the magnetic tape 12, information regarding the tension generated in the magnetic tape 12, and information regarding the amplitude of the magnetic tape 12. Further, among the magnetic tape information, the information regarding the property of the magnetic tape 12 includes information regarding the thickness of the magnetic tape 12 and information regarding the material of the magnetic tape 12.

The magnetic tape drive 10 is provided with various sensors. Various sensors detect the transport state of the magnetic tape 12. That is, a speed sensor 83 detects the transport speed of the magnetic tape 12 from the rotational speed of the feeding motor 25 and the winding-up motor 26. The speed sensor 83 outputs speed information indicating the speed of the magnetic tape 12 to the controller 31. Further, a tension sensor 84 detects the tension generated in the magnetic tape 12 from the torque generated in the feeding motor 25 and the winding-up motor 26. The tension sensor 84 outputs tension information indicating the tension generated in the magnetic tape 12, to the controller 31. Further, a displacement sensor 85 detects the amplitude of the magnetic tape 12. The displacement sensor 85 outputs amplitude information indicating the amplitude of the magnetic tape 12 to the controller 31. The speed sensor 83, the tension sensor 84, and the displacement sensor 85 are an example of the “sensor” according to the technique of the present disclosure.

The first vibration source controller 81 controls the operation of the ultrasonic vibration source 33A on the basis of the detection results of the speed sensor 83, the tension sensor 84, and the displacement sensor 85. The second vibration source controller 82 controls the operation of the ultrasonic vibration source 33B on the basis of the detection results of the speed sensor 83, the tension sensor 84, and the displacement sensor 85. For example, the first vibration source controller 81 and the second vibration source controller 82 operate the ultrasonic vibration sources 33A and 33B so as to increase the frequencies in a case where the transport speed of the magnetic tape 12 detected by the speed sensor 83 increases.

Further, the first vibration source controller 81 and the second vibration source controller 82 operate the ultrasonic vibration sources 33A and 33B so as to increase the frequencies in a case where the tension generated in the magnetic tape 12, which is detected by the tension sensor 84, increases. This is because, in a case where the natural frequency of the magnetic tape 12 increases because of the increase in tension generated in the magnetic tape 12, the ultrasonic vibration sources 33A and 33B are each operated at a frequency equal to or higher than the changed natural frequency. The ultrasonic vibration sources 33A and 33B vibrate at a frequency equal to or higher than the natural frequency, whereby the magnetic tape 12 cannot follow the vibration of the ultrasonic vibration sources 33A and 33B. With this, the influence of the vibration of the ultrasonic vibration sources 33A and 33B on the magnetic tape 12 is restrained.

Further, the first vibration source controller 81 and the second vibration source controller 82 operate the ultrasonic vibration sources 33A and 33B so as to increase the frequencies in a case where the amplitude of the magnetic tape 12 detected by the displacement sensor 85 increases. In this way, in a case where the amplitude of the magnetic tape 12 increases, the frequencies of the ultrasonic vibration sources 33A and 33B are increased, whereby a frequency region in which the magnetic tape 12 cannot follow the vibration of the ultrasonic vibration sources 33A and 33B can be made.

The cartridge 11 is provided with a cartridge memory 11A. The controller 31 acquires information regarding the property of the magnetic tape 12 from the cartridge memory 11A. The information regarding the property of the magnetic tape 12 (for example, the thickness and the material of the magnetic tape 12) is stored in the cartridge memory 11A. The controller 31 acquires information regarding the property of the magnetic tape 12 from the cartridge memory 11A via, for example, a non-contact read/write device 11B. The non-contact read/write device 11B exchanges information between the controller 31 and the cartridge memory 11A via a magnetic field under the control of the controller 31.

The controller 31 operates the ultrasonic vibration sources 33A and 33B on the basis of the information regarding the property of the magnetic tape 12 acquired via the non-contact read/write device 11B. For example, the controller 31 calculates a frequency equal to or higher than the natural frequency of the magnetic tape 12 on the basis of the thickness and the material of the magnetic tape 12. The controller 31 operates the ultrasonic vibration sources 33A and 33B at a frequency equal to or higher than the natural frequency of the magnetic tape 12.

Further, the information regarding the magnetic tape 12 may include information on the magnetic tape 12, such as the date of manufacture, the manufacture unique number, the manufacturer, or the number of times of use.

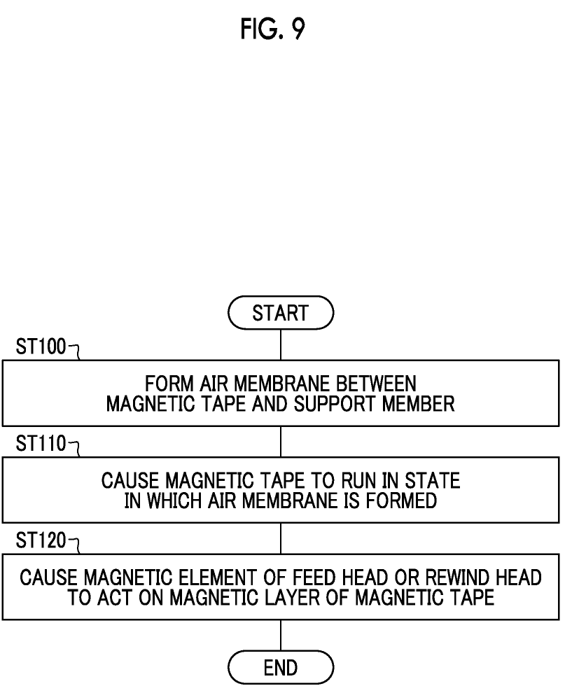

Hereinafter, the action of the above configuration will be described with reference to the flowchart of FIG. 9. As shown in FIG. 9 as an example, first, in step ST100, the ultrasonic vibration sources 33A and 33B ultrasonically vibrate under the control of the first vibration source controller 81 and the second vibration source controller 82. With this, the squeeze membrane is generated as the air membrane AM between the back surface 19 of the magnetic tape 12 and the support member 30.

In the next step ST110, the feeding motor 25 and the winding-up motor 26 are operated under the control of the running controller 60, and the magnetic tape 12 runs in the feed direction FWD or the rewind direction BWD. With this, the magnetic tape 12 runs in a state in which the air membrane AM is formed between the magnetic tape 12 and the support member 30.

Then, in step ST120, the magnetic element of the feed head 28 or the rewind head 29 magnetically acts on the magnetic layer 16 of the magnetic tape 12. Specifically, the servo pattern 50 is read by the servo pattern reading element SR. Further, data is recorded on the data track DT by the data recording element DW under the control of the first recording controller 64 or the second recording controller 70. Further, data is read from the data track DT by the data reading element DR under the control of the first read controller 65 or the second read controller 71.

The first position detection unit 61 or the second position detection unit 67 detects the position of the feed head 28 in the width direction WD or the position of the rewind head 29 in the width direction WD from the interval of the servo signals based on the servo pattern 50. The first servo controller 62 or the second servo controller 68 compares the detection result of the position of the first position detection unit 61 or the second position detection unit 67 with the target position, and performs the servo control for making the position of the feed head 28 or the rewind head 29 equal to the target position.

As described above, in the magnetic tape drive 10 according to the first embodiment, the air membrane AM is formed between the magnetic tape 12 and the support member 30. Accordingly, with this configuration, the friction is restrained from being generated between the magnetic tape 12 and the support member 30, as compared with a case where the support member 30 that is provided on the side opposite to the magnetic head with the magnetic tape 12 interposed therebetween is directly pressed against the magnetic tape 12.

Further, in the magnetic tape drive 10 according to the first embodiment, the ultrasonic vibration sources 33A and 33B ultrasonically vibrate the support member 30 in the direction orthogonal to the longitudinal direction of the magnetic tape 12 and orthogonal to the width direction WD of the magnetic tape 12. With this, the air membrane AM is formed between the magnetic tape 12 and the support member 30. Accordingly, with this configuration, the friction is restrained from being generated between the magnetic tape 12 and the support member 30, as compared with a case where the air membrane AM is formed by a method other than the ultrasonic vibration.

Further, in the magnetic tape drive 10 according to the first embodiment, the air membrane AM is the squeeze membrane. Accordingly, with this configuration, the gap (that is, spacing) between the magnetic tape 12 and the support member 30 is restrained from varying, as compared with a case where the air membrane AM thicker than the squeeze membrane is formed between the magnetic tape 12 and the support member 30.

Further, in the magnetic tape drive 10 according to the first embodiment, the ultrasonic vibration sources 33A and 33B vibrate at a frequency equal to or higher than the natural frequency. Accordingly, with this configuration, the gap between the magnetic head and the magnetic tape 12 is restrained from varying, as compared with a case where the ultrasonic vibration sources 33A and 33B vibrate at a frequency lower than the natural frequency of the magnetic tape 12.

Further, in the magnetic tape drive 10 according to the first embodiment, the ultrasonic vibration sources 33A and 33B vibrate the support member 30 at a frequency at which the amplitude of the magnetic tape 12 is within a predetermined range. Accordingly, with this configuration, the gap between the magnetic head and the magnetic tape 12 is restrained from varying, as compared with a case where the ultrasonic vibration sources 33A and 33B vibrate at a frequency at which the amplitude of the magnetic tape 12 is outside the predetermined range.

Further, in the magnetic tape drive 10 according to the first embodiment, the first vibration source controller 81 and the second vibration source controller 82 control the ultrasonic vibration sources 33A and 33B, respectively, on the basis of the magnetic tape information. Accordingly, with this configuration, since the ultrasonic vibration sources 33A and 33B vibrate on the basis of the magnetic tape information, the gap between the magnetic head and the magnetic tape 12 is restrained from varying, as compared with a case where the magnetic tape information is not taken into consideration.

Further, in the magnetic tape drive 10 according to the first embodiment, the magnetic tape information includes the information regarding the transport state of the magnetic tape 12 and the information regarding the property of the magnetic tape 12. Accordingly, with this configuration, the gap between the magnetic head and the magnetic tape 12 is restrained from varying, as compared with a case where the transport state of the magnetic tape 12 and the property of the magnetic tape 12 are not taken into consideration as the magnetic tape information.

Further, in the magnetic tape drive 10 according to the first embodiment, the information regarding the transport state of the magnetic tape 12 includes the information regarding the transport speed of the magnetic tape 12, the information regarding the tension generated in the magnetic tape 12, and the information regarding the amplitude of the magnetic tape 12. Accordingly, with this configuration, the gap between the magnetic head and the magnetic tape 12 is restrained from varying, as compared with a case where the transport speed of the magnetic tape 12, the tension generated in the magnetic tape 12, and the amplitude of the magnetic tape 12 are not taken into consideration as the transport state of the magnetic tape 12.

Further, in the magnetic tape drive 10 according to the first embodiment, the information regarding the property of the magnetic tape 12 includes the information regarding the thickness of the magnetic tape 12 and the information regarding the material of the magnetic tape 12. Accordingly, with this configuration, the gap between the magnetic head and the magnetic tape 12 is restrained from varying, as compared with a case where the thickness of the magnetic tape 12 and the material of the magnetic tape 12 are not taken into consideration as the property of the magnetic tape 12.

Further, in the magnetic tape drive 10 according to the first embodiment, the sensor that detects the transport state of the magnetic tape 12 is provided, and the operations of the ultrasonic vibration sources 33A and 33B are controlled on the basis of the detection result of the sensor. Accordingly, with this configuration, the gap between the magnetic head and the magnetic tape 12 is restrained from varying, as compared with a case where constant ultrasonic vibration is always performed regardless of the detection result of the transport state of the magnetic tape 12.

Further, in the magnetic tape drive 10 according to the first embodiment, the magnetic head is displaced by the suspensions 35 and 36 in the direction approaching the magnetic tape 12. Accordingly, with this configuration, the gap between the magnetic head and the magnetic tape 12 is restrained from varying, as compared with a case where the position of the magnetic head is always constant.

In the above first embodiment, an aspect in which the information regarding the transport state of the magnetic tape 12 includes the information regarding the transport speed of the magnetic tape 12, the tension generated in the magnetic tape 12, and the amplitude of the magnetic tape 12 has been described as an example, but the technique of the present disclosure is not limited thereto. For example, as the information regarding the transport state of the magnetic tape 12, any one or two of the information regarding the transport speed of the magnetic tape 12, the information regarding the tension generated in the magnetic tape 12, and the information regarding the amplitude of the magnetic tape 12 may be used.

Further, in the above first embodiment, an aspect in which the information regarding the property of the magnetic tape 12 includes the information regarding the thickness of the magnetic tape 12 and the material of the magnetic tape 12 has been described as an example, but the technique of the present disclosure is not limited thereto. For example, as the information regarding the property of the magnetic tape 12, either the information regarding the thickness of the magnetic tape 12 or the information regarding the material of the magnetic tape 12 may be used.

Further, in the above first embodiment, an aspect in which the operations of the ultrasonic vibration sources 33A and 33B are controlled on the basis of the detection results of the speed sensor 83, the tension sensor 84, and the displacement sensor 85 has been described as an example, but the technique of the present disclosure is not limited thereto. For example, the operations of the ultrasonic vibration sources 33A and 33B may be controlled on the basis of the detection results of any one or two of the speed sensor 83, the tension sensor 84, and the displacement sensor 85.

### Second Embodiment

In the above first embodiment, an example in which the position of the magnetic head is adjusted by the suspensions 35 and 36 has been described, but the technique of the present disclosure is not limited thereto. In the second embodiment, an aspect in which the position of the magnetic head is also adjusted by a position adjusting actuator, in addition to the suspensions 35 and 36, will be described as an example. A magnetic tape drive 10A according to the second embodiment is provided with the position adjusting actuator that adjusts the position of the magnetic head. In the second embodiment, the description of the configuration common to the first embodiment will be omitted.

As shown in FIG. 10 as an example, in the magnetic tape drive 10A, the suspension 35 has a load beam 55, a piezoelectric bimorph element 56, and a flexure 57. The load beam 55 is a thin flat plate made of metal having relatively high rigidity. The load beam 55 is attached to a base plate whose proximal end is not shown. The load beam 55 is connected to an actuator (for example, a voice coil motor) of the movement mechanism 40 via the base plate. The load beam 55 is formed so as to be slightly shorter in length than the flexure 57. The piezoelectric bimorph element 56 is fixed to the distal end of the load beam 55.

The piezoelectric bimorph element 56 consists of flat plate-shaped piezoelectric bodies 56A and 56B. The flat plate-shaped piezoelectric bodies 56A and 56B are joined to each other in a state of being laminated in the plate thickness direction. One of the piezoelectric bodies 56A and 56B expands and the other contracts in a case where a voltage is applied. The piezoelectric bimorph element 56 is an element that is bent by the expansion and contraction of the piezoelectric bodies 56A and 56B to move a target. The piezoelectric bodies 56A and 56B are, for example, lead zirconate titanate (PZT; Pb(Zr,Ti)O₃). The side of the piezoelectric bimorph element 56 on the side of the piezoelectric body 56B is attached to the flexure 57. The piezoelectric bimorph element 56 is an example of the “position adjusting actuator” according to the technique of the present disclosure.

The flexure 57 is a thin flat plate made of metal having a relatively low rigidity. Therefore, the flexure 57 functions as a leaf spring. The feed head 28 is attached to the surface of the flexure 57 facing the surface to which the piezoelectric bimorph element 56 is attached.

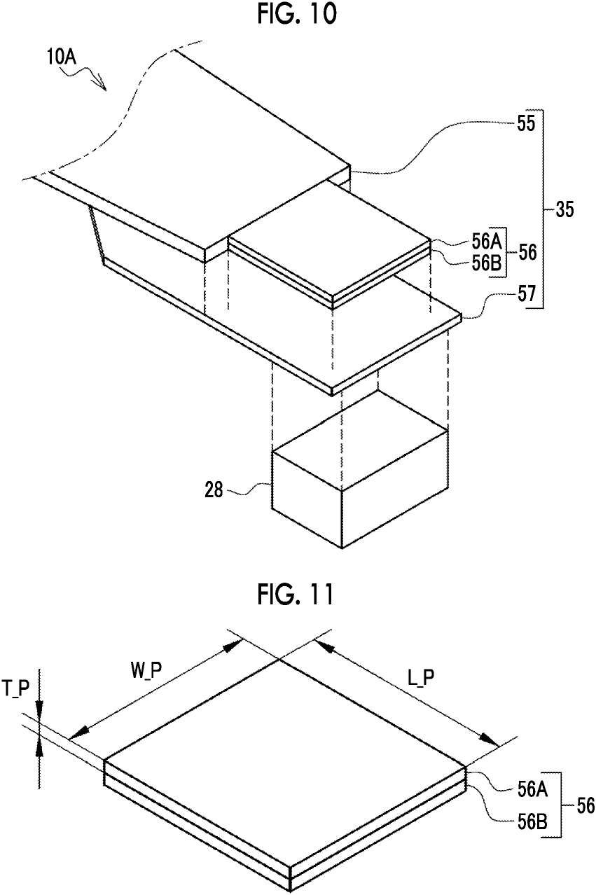

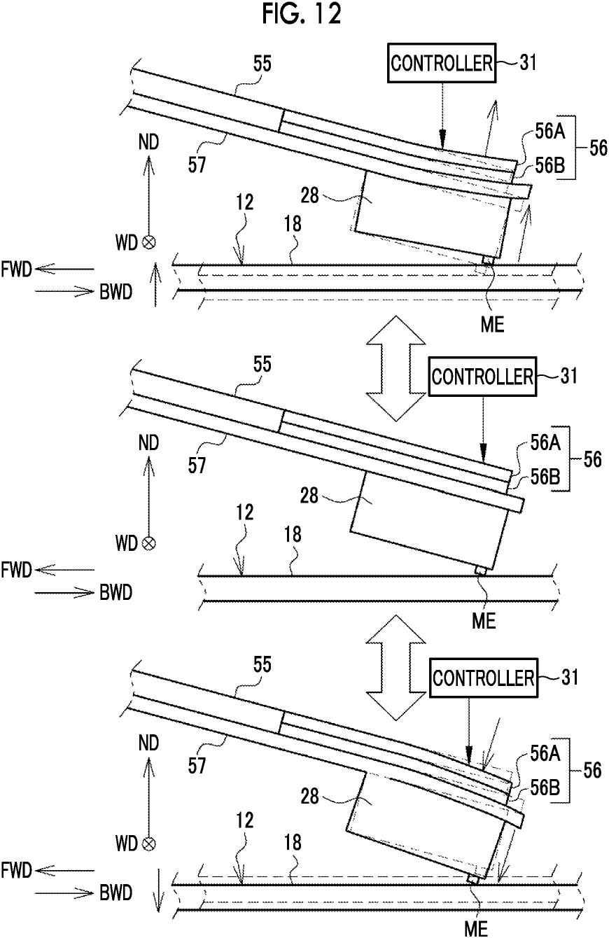

As shown in FIG. 11 as an example, a length L_P and a width W_P of each of the piezoelectric bodies 56A and 56B are both several mm. A thickness T_P of each of the piezoelectric bodies 56A and 56B is several tens of µm.

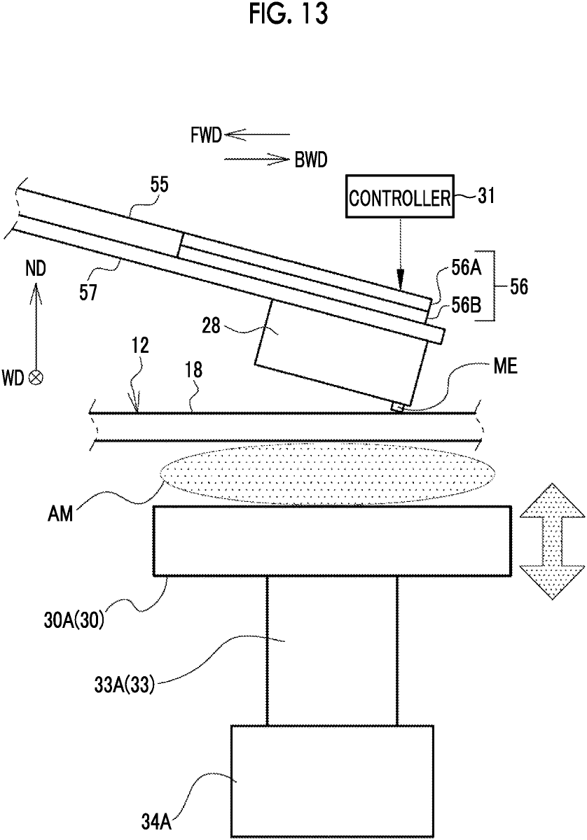

As shown in the upper part of FIG. 12 as an example, the piezoelectric bimorph element 56 bends the distal end of the flexure 57 by the expansion and contraction of the piezoelectric bodies 56A and 56B to move the feed head 28, thereby adjusting the position of a magnetic element ME in the normal direction ND. That is, the piezoelectric bimorph element 56 adjusts the position of the feed head 28 along the direction orthogonal to the longitudinal direction of the magnetic tape 12 and orthogonal to the width direction WD of the magnetic tape 12.

The piezoelectric bimorph element 56 operates so as to keep the spacing constant, under the control of the controller 31. Specifically, in a case where the position of the magnetic tape 12 deviates in the direction of the feed head 28 from the regular position shown in the middle part of FIG. 12, the piezoelectric bimorph element 56 is bent in a direction away from the magnetic tape 12 as shown in the upper part of FIG. 12. On the other hand, in a case where the position of the magnetic tape 12 deviates in the direction opposite to the feed head 28 from the regular position shown in the middle part of FIG. 12, the piezoelectric bimorph element 56 is bent in a direction approaching the magnetic tape 12 as shown in the lower part of FIG. 12.

A bending amount ΔL in one direction of the piezoelectric bimorph element 56 is represented by Equation (1). In Equation (1), d is a piezoelectric strain constant and V is an applied voltage.

$$Δ \text{L} = \frac{3}{4} {\left(\frac{\text{L\_P}}{\text{T\_P}}\right)}^{2} ⋅ \text{d} ⋅ \text{V}$$

Here, for example, a case where the length L_P and the width W_P of each of the piezoelectric bodies 56A and 56B are both 1 mm and the thickness T_P of each of the piezoelectric bodies 56A and 56B is 50 µm is considered. In a case where the piezoelectric strain constant d of each of the piezoelectric bodies 56A and 56B is, for example, 200 x 10⁻¹² m/V, and a voltage of, for example, 20 V is applied to the piezoelectric bodies 56A and 56B, the bending amount ΔL is 1.2 µm according to Equation (1).

The feed head 28 has a plurality of magnetic elements ME on the surface facing the magnetic layer 16. The plurality of magnetic elements ME magnetically act on the magnetic layer 16. The feed head 28 causes the magnetic element ME to magnetically act on the magnetic layer 16 by bringing the magnetic element ME close to the magnetic layer 16 with spacing on the order of several nm therebetween.

In the above second embodiment, a case where the position of the feed head 28 is adjusted by the piezoelectric bimorph element 56 has been described, but the position of the rewind head 29 is also adjusted by the piezoelectric bimorph element in the same manner.

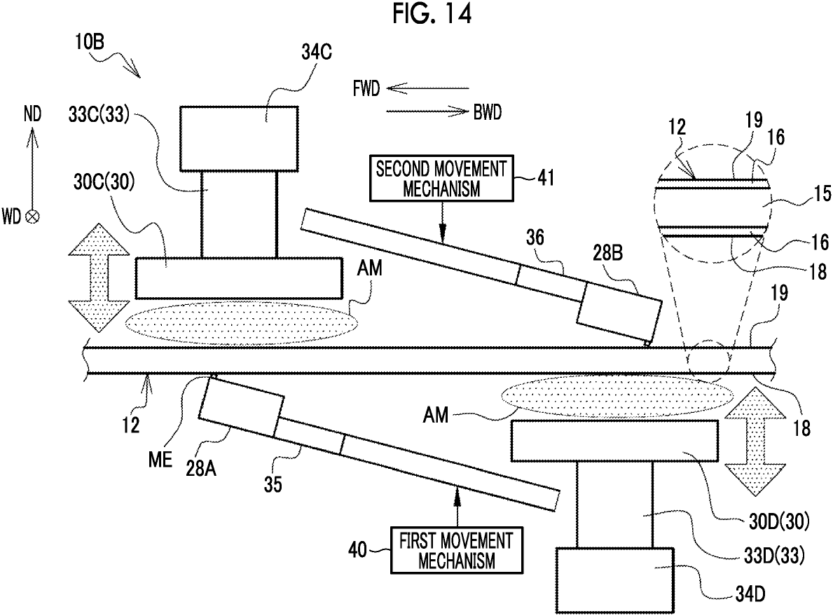

As shown in FIG. 13 as an example, the feed support member 30A is disposed at a position facing the feed head 28 with the magnetic tape 12 interposed therebetween. The ultrasonic vibration source 33A is connected to the feed support member 30A. The ultrasonic vibration source 33A vibrates the feed support member 30A in the direction orthogonal to the longitudinal direction of the magnetic tape 12 and orthogonal to the width direction WD of the magnetic tape 12 (that is, the normal direction ND). With this, the air membrane AM is formed between the magnetic tape 12 and the feed support member 30A.

As described above, in the magnetic tape drive 10A according to the second embodiment, the position of the magnetic head is adjusted by the piezoelectric bimorph element 56. Accordingly, with this configuration, the gap between the magnetic head and the magnetic tape 12 is restrained from varying, as compared with a case where the position of the magnetic head is always constant.

That is, the position of the magnetic head is adjusted by the piezoelectric bimorph element 56, whereby the preload applied to the magnetic tape 12 is reduced. As a result, the gap between the magnetic head and the magnetic tape 12 can be further restrained from varying, as compared with a case where the position of the magnetic head is always constant.

### Third Embodiment

In the above first and second embodiments, an example in which the magnetic layer 16 on the front surface 18 of the magnetic tape 12 is provided has been described, but the technique of the present disclosure is not limited thereto. In a magnetic tape drive 10B according to the third embodiment, read/write with respect to the magnetic tape 12 is realized even in a case where the magnetic layer 16 is formed not only on the front surface 18 but also on the back surface 19 of the magnetic tape 12. In the third embodiment, the description of the configuration common to the first and second embodiments will be omitted.

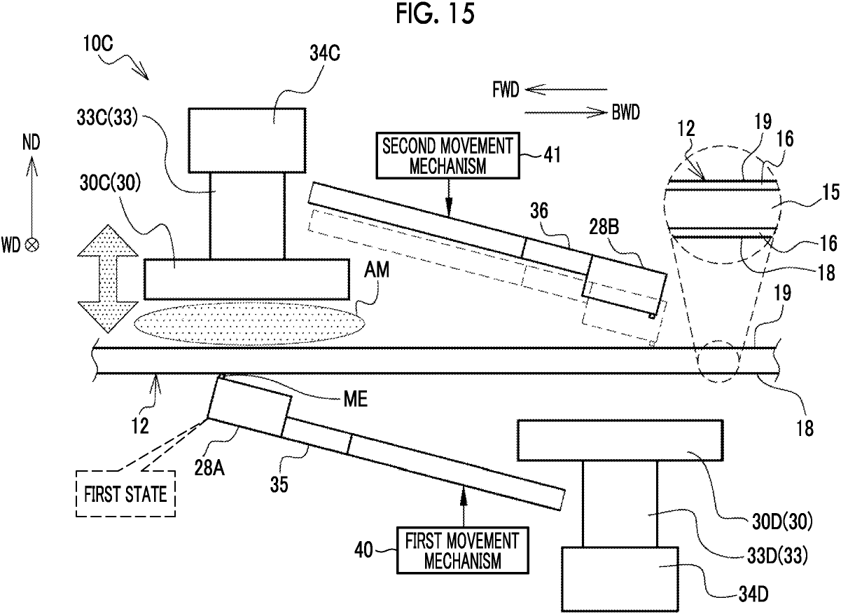

As shown in FIG. 14 as an example, in the magnetic tape drive 10B, the magnetic layer 16 is formed on the front surface 18 of the magnetic tape 12. In addition, the magnetic layer 16 is formed on the back surface 19 of the magnetic tape 12. That is, the magnetic tape 12 has magnetic layers 16 on both surfaces.

A first feed head 28A is disposed on the side of the front surface 18 of the magnetic tape 12 in order to access the magnetic layer 16 formed on the front surface 18. Further, a second feed head 28B is disposed on the side of the back surface 19 of the magnetic tape 12 in order to access the magnetic layer 16 formed on the back surface 19. The first feed head 28A and the second feed head 28B operate in a case where the magnetic tape 12 is running in the feed direction FWD. The second feed head 28B is an example of the “second magnetic head” according to the technique of the present disclosure.

A feed support member 30C is disposed at a position facing the first feed head 28A with the magnetic tape 12 interposed therebetween. Further, a feed support member 30D is disposed at a position facing the second feed head 28B with the magnetic tape 12 interposed therebetween.

The magnetic tape drive 10B comprises the air membrane forming device 33. The air membrane forming device 33 forms the air membrane AM between the feed support members 30C and 30D, and the magnetic tape 12. As an example, the air membrane forming device 33 comprises ultrasonic vibration sources 33C and 33D.

The ultrasonic vibration source 33C is connected to the feed support member 30C. The ultrasonic vibration source 33D is connected to the feed support member 30D. Further, the ultrasonic vibration source 33C is fixed to the magnetic tape drive 10B via a fixing member 34C. The ultrasonic vibration source 33D is fixed to the magnetic tape drive 10B via a fixing member 34D.

The ultrasonic vibration source 33C ultrasonically vibrates the feed support member 30C in the direction orthogonal to the longitudinal direction of the magnetic tape 12 and orthogonal to the width direction WD of the magnetic tape 12 (that is, the normal direction ND). With this, the air membrane AM is formed between the feed support member 30C and the back surface 19 of the magnetic tape 12. Further, the ultrasonic vibration source 33D ultrasonically vibrates the feed support member 30D in the normal direction ND of the magnetic tape 12. With this, the air membrane AM is formed between the feed support member 30D and the front surface 18 of the magnetic tape 12.

The second feed head 28B and the feed support member 30D are disposed at different positions from the first feed head 28A and the feed support member 30C in the longitudinal direction of the magnetic tape 12, respectively. That is, the second feed head 28B and the feed support member 30D are disposed on the side of the rewind direction BWD with respect to the first feed head 28A and the feed support member 30C in the longitudinal direction of the magnetic tape 12, respectively.

As described above, in the magnetic tape drive 10B according to the third embodiment, the air membrane AM is formed between the feed support member 30C and the back surface 19 of the magnetic tape 12. Further, the air membrane AM is formed between the feed support member 30D and the front surface 18 of the magnetic tape 12. Since the magnetic tape 12 is supported via the air membrane AM, the influence on the magnetic layer 16 caused by the friction or the like during transportation is restrained even in a case where the magnetic layer 16 is formed on both the front surface 18 and the back surface 19. Accordingly, with this configuration, in a case where the magnetic layer 16 is formed on both the front surface 18 and the back surface 19 of the magnetic tape 12, a magnetic tape drive capable of reading/writing with respect to the magnetic tape 12 is also realized.

### Modification Example

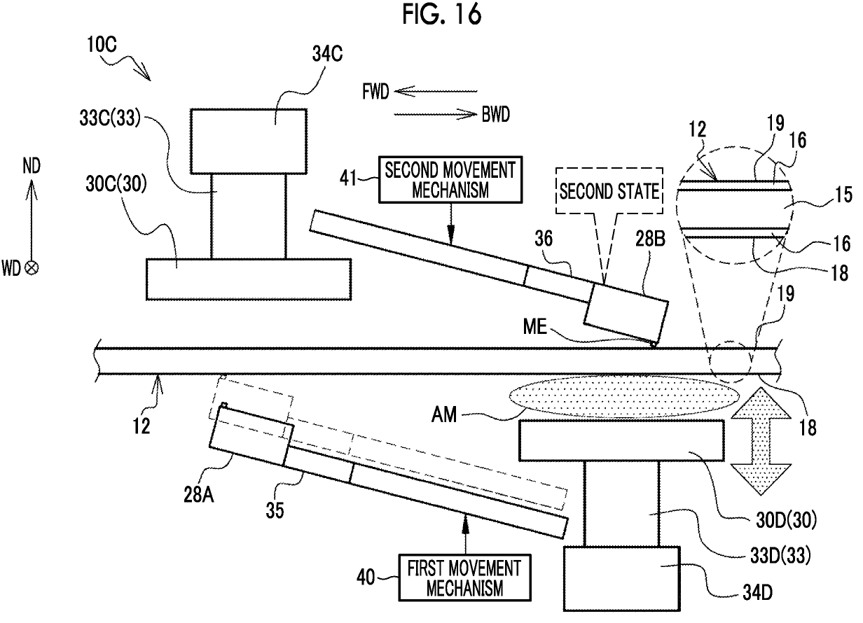

In the above third embodiment, an aspect in which the first feed head 28A and the second feed head 28B act on the magnetic layers 16 of the magnetic tape 12 at the same time has been described as an example, but the technique of the present disclosure is not limited thereto. As shown in FIG. 15 as an example, in a magnetic tape drive 10C according to the modification example, a state in which the first feed head 28A acts on the magnetic layer 16 on the front surface 18 of the magnetic tape 12 and a state in which the second feed head 28B acts on the magnetic layer 16 on the back surface 19 of the magnetic tape 12 can be switched therebetween.

The proximal ends of the suspensions 35 and 36 are movably attached to the frame of the magnetic tape drive 10 via, for example, an arm. In the magnetic tape drive 10C, when the second feed head 28B is not in operation, the second feed head 28B is moved to a standby position away from the magnetic tape 12 by the second movement mechanism 41. In this case, as a result of the ultrasonic vibration source 33D not performing ultrasonic vibration, the air membrane AM is not formed between the feed support member 30D and the magnetic tape 12. On the other hand, the first feed head 28A is displaced in a direction approaching the front surface 18 of the magnetic tape 12. Further, the air membrane AM is formed between the feed support member 30C and the magnetic tape 12. That is, a first state in which the magnetic element ME of the first feed head 28A acts on the magnetic layer 16 on the front surface 18 of the magnetic tape 12 is realized.

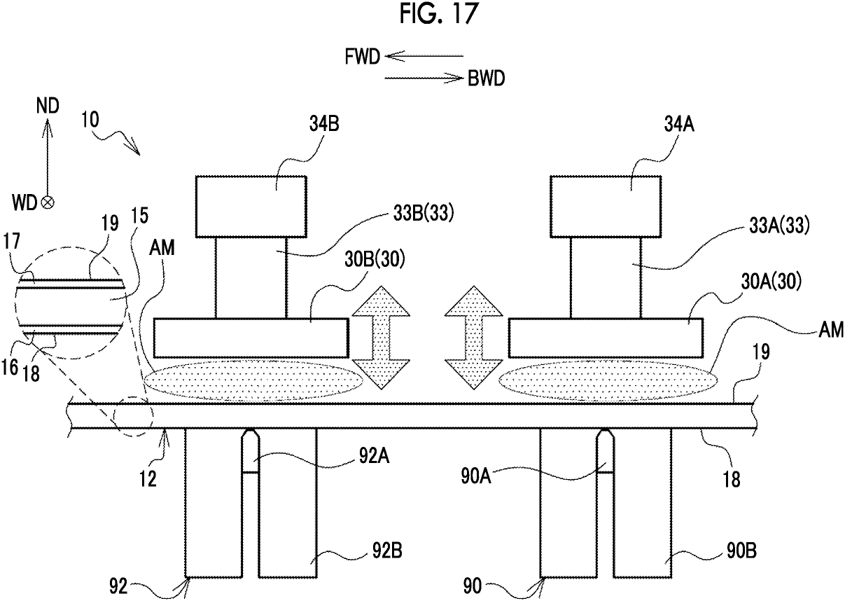

On the other hand, as shown in FIG. 16 as an example, when the first feed head 28A is not in operation, the first feed head 28A is moved to a standby position away from the magnetic tape 12 by the first movement mechanism 40. In this case, as a result of the ultrasonic vibration source 33C not performing ultrasonic vibration, the air membrane AM is not formed between the feed support member 30C and the magnetic tape 12. On the other hand, the second feed head 28B is displaced in a direction approaching the back surface 19 of the magnetic tape 12. Further, the air membrane AM is formed between the feed support member 30D and the magnetic tape 12. That is, a second state in which the magnetic element ME of the second feed head 28B acts on the magnetic layer 16 on the back surface 19 of the magnetic tape 12 is realized. The magnetic element ME of the second feed head 28B is an example of the “second magnetic element” according to the technique of the present disclosure.

As described above, in the magnetic tape drive 10C, it is possible to switch between the state in which the magnetic element ME of the first feed head 28A acts on the magnetic layer 16 on the front surface 18 of the magnetic tape 12 and the state in which the magnetic element ME of the second feed head 28B acts on the magnetic layer 16 on the back surface 19 of the magnetic tape 12.

As described above, in the magnetic tape drive 10C according to the modification example, the air membrane AM is formed between the feed support member 30C and the back surface 19 of the magnetic tape 12. Further, the air membrane AM is formed between the feed support member 30D and the front surface 18 of the magnetic tape 12. Since the magnetic tape 12 is supported via the air membrane AM, the influence on the magnetic layer 16 caused by the friction or the like during transportation is restrained even in a case where the magnetic layer 16 is formed on both the front surface 18 and the back surface 19. Accordingly, with this configuration, in a case where the magnetic layer 16 is formed on both the front surface 18 and the back surface 19 of the magnetic tape 12, a magnetic tape drive capable of reading/writing with respect to the magnetic tape 12 is also realized.

Further, in the magnetic tape drive 10C according to the modification example, the first state and the second state can be switched therebetween. Accordingly, with this configuration, it is realized that data can be read/written only with respect to either the front surface 18 or the back surface 19 even in a case where the magnetic layer is formed on both surfaces of the magnetic tape 12.

In the above third embodiment and the above modification example, an aspect in which the first feed head 28A and the second feed head 28B act on the front surface 18 and the back surface 19 of the magnetic tape 12, respectively, has been described as an example, but the technique of the present disclosure is not limited thereto. For example, the rewind head (not shown) can have the same configuration. That is, two rewind heads that act on the respective magnetic layers 16 on the front surface 18 and the back surface 19 of the magnetic tape 12 may be provided. Further, the rewind support member (not shown) may be disposed at a position facing the rewind head with the magnetic tape 12 interposed therebetween, and the air membrane is formed between the rewind support member and the magnetic tape 12.

In each of the above embodiments, an aspect in which the ultrasonic vibration source is provided as the air membrane forming device 33 has been described as an example, but the technique of the present disclosure is not limited thereto. For example, as the air membrane forming device 33, air is injected between the support member 30 and the magnetic tape 12 so that the air membrane AM may be formed between the support member 30 and the magnetic tape 12. As an example, a plurality of injection ports are provided at the part of the support member 30 facing the magnetic tape 12. The plurality of injection ports are dispersedly provided in the part of the support member 30 facing the magnetic tape 12. Air is injected toward the magnetic tape 12 via the plurality of injection ports so that the air membrane AM is formed between the support member 30 and the magnetic tape 12.

Further, in each of the above embodiments, an aspect in which the magnetic heads are provided at the distal ends of the leaf spring type suspensions 35 and 36 has been described as an example, but the technique of the present disclosure is not limited thereto. As shown in FIG. 17 as an example, the read/write with respect to the magnetic tape 12 may be performed by a reading head 90 and a recording head 92. The reading head 90 comprises a magnetic element unit 90A and a holder 90B. The magnetic element unit 90A is held by the holder 90B so as to come close to or come into contact with the running magnetic tape 12. The magnetic element unit 90A reads data from the magnetic tape 12 or reads the servo pattern 50 (see FIG. 3) from the magnetic tape 12.

The recording head 92 comprises a magnetic element unit 92A and a holder 92B. The magnetic element unit 92A is held by the holder 92B so as to come close to or come into contact with the running magnetic tape 12. The magnetic element unit 92A records data on the magnetic tape 12 or reads the servo pattern 50 (see FIG. 3) from the magnetic tape 12.

The support members 30 are provided at positions facing the reading head 90 and the recording head 92 with the magnetic tape 12 interposed therebetween, respectively. The air membrane AM is formed between the support member 30 and the magnetic tape 12 by the air membrane forming device 33.

Further, the number of servo bands SB, the number of data bands DB, the number of data elements DRW, the number of data tracks DT that one data element DRW is in charge of, and the like shown in each of the above embodiments are merely an example, and the technique of the present disclosure is not particularly limited thereto.

For example, a magnetic tape 12 in which five servo bands SB and four data bands DB are alternately arranged along the width direction WD may be used. In this case, two feed heads and two rewind heads are provided. The width of each magnetic head is about ¼ of the width of the magnetic tape 12. Further, the magnetic heads are disposed so as to be shifted from each other in the feed direction FWD and the rewind direction BWD such that the magnetic heads do not interfere with each other. The support members are disposed at positions facing the magnetic heads with the magnetic tape 12 interposed therebetween, respectively. The air membrane is formed between the support member and the magnetic tape 12 by the air membrane forming device.

Alternatively, a magnetic tape in which nine servo bands SB and eight data bands DB are alternately arranged along the width direction WD may be used. In this case, four feed heads and four rewind heads are provided. The width of each of the feed head and the rewind head is about ⅛ of the width of the magnetic tape. The support members are disposed at positions facing these magnetic heads with the magnetic tape 12 interposed therebetween, respectively. The air membrane is formed between the support member and the magnetic tape 12 by the air membrane forming device.

Alternatively, a magnetic tape in which 13 servo bands SB and 12 data bands DB are alternately arranged along the width direction WD may be used. In this case, six feed heads and six rewind heads are provided. The width of each of the feed head and the rewind head is about 1/12 of the width of the magnetic tape. The support members are disposed at positions facing the magnetic heads with the magnetic tape 12 interposed therebetween, respectively. The air membrane is formed between the support member and the magnetic tape 12 by the air membrane forming device.

Further, in each of the above embodiments, an aspect in which the feed head and the rewind head are provided as separate bodies has been described as an example, but the technique of the present disclosure is not limited thereto. For example, one magnetic head may be shared for feed/rewind without separating the feed head and the rewind head from each other. Further, the number of servo pattern reading elements SR disposed in one magnetic head may be one. Similarly, the number of data elements DRW disposed in one magnetic head may be one.

The number of data elements DRW disposed in one magnetic head may be, for example, 16, 32, or 64. Further, the number of data tracks DT that one data element DRW is in charge of for data recording and/or data reading is not limited to 12 that is shown as an example. The number of data tracks DT may be 1, or may be, for example, 4, 16, 32, or 64.

Further, in each of the above embodiments, an example in which the magnetic tape drive 10 in which the cartridge 11 is loaded has been shown, but the technique of the present disclosure is not limited thereto. For example, the magnetic tape 12 as it is in which the cartridge 11 is not housed may be a magnetic tape device wound around a feed reel, that is, a magnetic tape device in which the magnetic tape 12 is irreplaceably installed.

Further, in each of the above embodiments, an aspect in which the magnetic tape 12 has the magnetic layer 16 containing ferromagnetic powder that is shown as an example, but the technique of the present disclosure is not limited thereto. For example, the magnetic tape 12 may be a magnetic tape in which a ferromagnetic thin film is formed by vacuum deposition, such as sputtering.

Further, in each of the above embodiments, the computer may include, for example, a programmable logic device (PLD) which is a processor whose circuit configuration can be changed after manufacture, such as a field-programmable gate array (FPGA), and/or a dedicated electrical circuit which is a processor having a dedicated circuit configuration designed to execute specific processing, such as an application specific integrated circuit (ASIC), in place of or in addition to the CPU operating as the controller 31.

The technique of the present disclosure can also appropriately combine the above-mentioned various embodiments and/or the above-mentioned various modification examples. In addition, it goes without saying that the technique of the present disclosure is not limited to the above embodiments and various configurations may be adopted without departing from the gist of the technique of the present disclosure.

The contents described and shown above are detailed descriptions of the parts related to the technique of the present disclosure, and are merely an example of the technique of the present disclosure. For example, the descriptions of the above configurations, functions, operations, and effects are the descriptions of an example of the configurations, functions, operations, and effects of the parts related to the technique of the present disclosure. Accordingly, it goes without saying that unnecessary parts may be deleted, new elements may be added, or replacements may be made with respect to the contents described and shown above, without departing from the gist of the technique of the present disclosure. Further, in order to avoid complications and facilitate understanding of the parts related to the technique of the present disclosure, descriptions of common general knowledge and the like that do not require special descriptions for enabling the implementation of the technique of the present disclosure are omitted, in the contents described and shown above.

In the present specification, “A and/or B” has the same meaning as “at least one of A or B”. That is, “A and/or B” means that only A may be used, only B may be used, or a combination of A and B may be used. In addition, in the present specification, the same concept as “A and/or B” is also applied to a case where three or more matters are expressed by “and/or”.

All documents, patent applications, and technical standards described in the present specification are incorporated in the present specification by reference to the same extent as in a case where the individual documents, patent applications, and technical standards were specifically and individually stated to be incorporated by reference.

What is claimed is:

1. A magnetic tape drive comprising:
a first magnetic head that has a first magnetic element acting on a magnetic layer formed on a first surface of a magnetic tape;
a first support member that is disposed at a position facing the first magnetic head with the magnetic tape interposed therebetween and faces a second surface which is a surface of the magnetic tape on a side opposite to the first surface; and
an air membrane forming device that forms an air membrane between the magnetic tape and the first support member.

2. The magnetic tape drive according to claim 1,
wherein the air membrane forming device is a first ultrasonic vibration source that ultrasonically vibrates the first support member in a direction orthogonal to a longitudinal direction of the magnetic tape and orthogonal to a width direction of the magnetic tape to form the air membrane between the magnetic tape and the first support member.

3. The magnetic tape drive according to claim 2,
wherein the air membrane is a squeeze membrane.

4. The magnetic tape drive according to claim 2,
wherein the first ultrasonic vibration source vibrates the first support member at a frequency at which a squeeze membrane is generated between the magnetic tape and the first support member, and
the frequency is a frequency higher than a natural frequency of the magnetic tape.

5. The magnetic tape drive according to claims 2,
wherein the first ultrasonic vibration source vibrates the first support member at a frequency at which amplitude of the magnetic tape is within a predetermined range.

6. The magnetic tape drive according to claims 2, further comprising:
a processor,
wherein the processor controls an operation of the first ultrasonic vibration source on the basis of magnetic tape information which is information regarding the magnetic tape.

7. The magnetic tape drive according to claim 6,
wherein the magnetic tape information includes information regarding a transport state of the magnetic tape and/or information regarding a property of the magnetic tape.

8. The magnetic tape drive according to claim 7,
wherein the information regarding the transport state of the magnetic tape includes information regarding a transport speed of the magnetic tape, information regarding tension generated in the magnetic tape, and/or information regarding amplitude of the magnetic tape.

9. The magnetic tape drive according to claim 7,
wherein the information regarding the property of the magnetic tape includes information regarding a thickness of the magnetic tape and/or information regarding a material of the magnetic tape.

10. The magnetic tape drive according to claim 7, further comprising:
a sensor that detects the transport state of the magnetic tape,
wherein the processor controls the operation of the first ultrasonic vibration source on the basis of a detection result of the sensor.

11. The magnetic tape drive according to claim 1, further comprising:
a leaf spring type suspension that supports the first magnetic head,
wherein the first magnetic head is provided at a distal end portion of the suspension, and
the suspension displaces the first magnetic head in a direction approaching the magnetic tape.

12. The magnetic tape drive according to claim 1, further comprising:
a position adjusting actuator that adjusts a position of the first magnetic head along a direction orthogonal to a longitudinal direction of the magnetic tape and orthogonal to a width direction of the magnetic tape.

13. The magnetic tape drive according to claim 1,
wherein the magnetic tape has a magnetic layer formed on the second surface,
the magnetic tape drive further comprises:
a second magnetic head that has a second magnetic element acting on the magnetic layer formed on the second surface;
a second support member that is disposed at a position facing the second magnetic head with the magnetic tape interposed therebetween and faces the first surface; and
an air membrane forming device that forms an air membrane between the magnetic tape and the second support member, and
the magnetic tape drive switches between a first state in which the first magnetic element acts on the magnetic layer formed on the first surface and a second state in which the second magnetic element acts on the magnetic layer formed on the second surface.

14. The magnetic tape drive according to claim 1,
wherein the magnetic tape has a magnetic layer formed on the second surface,
the magnetic tape drive further comprises:
a second magnetic head that has a second magnetic element acting on the magnetic layer formed on the second surface;
a second support member that is disposed at a position facing the second magnetic head with the magnetic tape interposed therebetween and faces the first surface; and
an air membrane forming device that forms an air membrane between the magnetic tape and the second support member, and
the second magnetic head and the second support member are disposed at different positions from the first magnetic head and the first support member in a longitudinal direction of the magnetic tape, respectively.

15. A method of operating a magnetic tape drive, comprising:
forming an air membrane between a magnetic tape and a support member that is disposed at a position facing a magnetic head with the magnetic tape interposed therebetween;
causing the magnetic tape to run in a state in which the air membrane is formed; and
causing the magnetic head to act on a magnetic layer of the magnetic tape.
